(19) United States
(12) Patent Application Publication
(10) Pub. No.: US 2019/0244284 A1
(43) Pub. Date: Aug. 8, 2019

(54) MANAGEMENT SYSTEM, BICYCLE, CONTROL METHOD, AND STORAGE MEDIUM

(71) Applicant: KYOCERA Corporation, Kyoto (JP)

(72) Inventors: Tomoaki MIWA, Fujisawa-shi, Kanagawa (JP); Atsuhiko KANDA, Yokohama-shi, Kanagawa (JP)

(73) Assignee: KYOCERA Corporation, Kyoto (JP)

(21) Appl. No.: 16/344,486

(22) PCT Filed: Oct. 25, 2017
(86) PCT No.: PCT/JP2017/038488

§ 371 Date: Apr. 24, 2019

(30) Foreign Application Priority Data
Oct. 26, 2016 (JP) 2016-209827
Oct. 26, 2016 (JP) 2016-209844
Oct. 26, 2016 (JP) 2016-209903

(51) Int. Cl. G06Q 30/06; G06Q 30/02; B62H 5/20; B62K 21/12; G06Q 50/30

(52) U.S. Cl. CPC G06Q 30/0645; G06Q 30/0284; B62H 5/20; B62H 2003/005; G06Q 50/30; B62K 2208/00; B62K 21/12

(57) ABSTRACT

A management system used in a bicycle rental service includes a power transmission interface that transmits power to a battery included in the bicycle, and an acquisition interface that acquires remaining battery level information related to the remaining level of the battery that receives power transmission from the power transmission interface. The management system further includes an input interface that receives input of destination information, a controller that identifies a bicycle based on the destination information and the remaining battery level information, and a presentation interface that presents information of the bicycle identified by the controller.

### CROSS-REFERENCE TO RELATED APPLICATIONS

The present application claims priority to and the benefit of Japanese Patent Application No. 2016-209903 filed Oct. 26, 2016, Japanese Patent Application No. 2016-209827 filed Oct. 26, 2016, and Japanese Patent Application No. 2016-209844 filed Oct. 26, 2016, the entire contents of which are incorporated herein by reference.

### TECHNICAL FIELD

The present disclosure relates to a management system, a bicycle, a control method, and a non-transitory computer-readable storage medium.

### BACKGROUND

Bicycle sharing systems in which a plurality of users can share bicycles parked in a bicycle parking lot exclusively for bicycle sharing are known. However, such bicycle sharing systems have room for improvement.

### SUMMARY

A management system according to an aspect is used in a bicycle rental service. The management system includes an acquisition interface configured to acquire remaining battery level information for a bicycle, a controller configured to identify a bicycle to rent out based on the remaining battery level information, and a presentation interface configured to present information of the bicycle identified by the controller.

A bicycle according to an aspect includes a battery and a controller configured to notify a management apparatus of a remaining level of the battery while the bicycle is parked at a bicycle parking facility.

A control method according to an aspect is for a management system used in a bicycle rental service. The control method includes acquiring remaining battery level information of a bicycle, identifying a bicycle to rent out based on the remaining battery level information, and presenting information of the identified bicycle.

A non-transitory computer-readable storage medium according to an aspect stores a program for causing a computer used in a bicycle rental service to execute the step of acquiring remaining battery level information of a bicycle. The program stored on the storage medium further causes the computer to execute the steps of identifying a bicycle to rent based on the remaining battery level information and presenting information of the identified bicycle.

### BRIEF DESCRIPTION OF THE DRAWINGS

In the accompanying drawings:

FIG. 1 illustrates the appearance of a management system, bicycles, and a storage medium of a first embodiment;

FIG. 2 is a side view of a bicycle;

FIG. 3 is a functional block diagram of a management apparatus, a bicycle, a storage medium, a power transmission apparatus, and a management server;

FIG. 4 illustrates an example image displayed when a destination and stopover are inputted;

FIG. 5 illustrates an example image that includes information related to bicycles;

FIG. 6 illustrates an example image displayed when directions are being provided;

FIG. 7 illustrates a power transmission apparatus in a power transmission facility;

FIG. 8 is a sequence diagram illustrating processing executed by a management system;

FIG. 9 is a continuation of the sequence diagram in FIG. 8;

FIG. 10 illustrates the subroutine in step S17 of FIG. 9;

FIG. 11 is a sequence diagram illustrating processing executed by a storage medium and a controller of a power transmission apparatus;

FIG. 12 is a sequence diagram illustrating processing executed by a management system in an eighth embodiment;

FIG. 13 is a side view of a bicycle in a ninth embodiment; and

FIG. 14 is a sequence diagram illustrating processing executed by a management system in the ninth embodiment.

### DETAILED DESCRIPTION

### First Embodiment

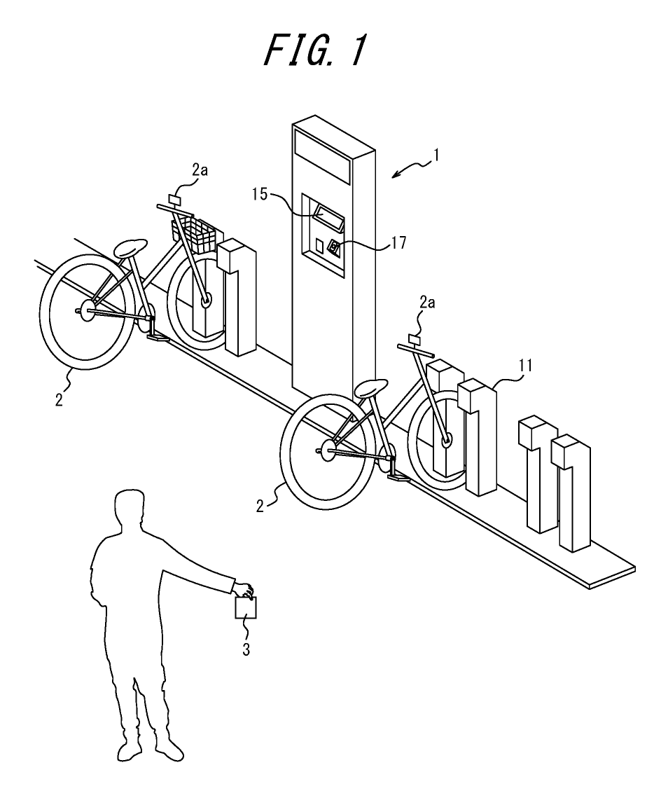

FIG. 1 illustrates the appearance of a management apparatus 1, bicycles 2, and a non-transitory computer-readable storage medium 3. The management apparatus 1 is provided in a bicycle parking facility called a port and is used in a rental service for renting out the bicycles 2. A plurality of the bicycle parking facilities may be installed in separate locations. This allows the user to borrow a bicycle 2 at one location and return it at a different location. The management apparatus 1 includes a presentation interface 15, for displaying various information, and presents various information to the user of the management apparatus 1 via the presentation interface 15.

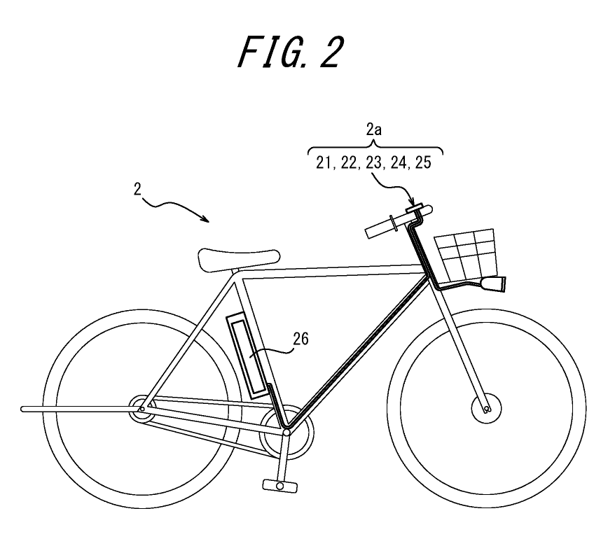

In the present embodiment, a detachable communication terminal 2a is attached to the handlebars of the bicycle 2, as illustrated in FIG. 2. The communication terminal 2a may be any type of terminal, such as a smartphone, a feature phone, a personal computer (PC), or a tablet PC. The communication terminal 2a includes a controller 21, a presentation interface 22, a first battery 23, a communication interface 24, and an input interface 25. The presentation interface 22 is oriented to be visible to a user seated on the bicycle 2. Power from the first battery 23 is used to drive the communication terminal 2a.

As an example, the bicycle 2 in the present embodiment is an electric bicycle. A second battery 26 of the bicycle 2 is attached near the seat tube below the saddle, as illustrated in FIG. 2. Power from the second battery 26 is used to drive an electric motor that propels the bicycle 2. At least one of the controller 21, the presentation interface 22, the first battery 23, the communication interface 24, the input interface 25, and the second battery 26 may be included inside the bicycle 2.

The bicycle 2 receives power transmitted from a power transmission interface 11 of the management apparatus 1 while the bicycle 2 is parked in a bicycle parking facility, as illustrated in FIG. 1. The first battery 23 and the second battery 26 are thus charged. At this time, the communication terminal 2a and the management apparatus 1 can communicate. Power transmission from the power transmission interface 11 ends when the remaining battery level of the first battery 23 or the second battery 26 is charged enough to change from being less than a threshold to being the threshold or greater. Communication between the communication terminal 2a and the communication interface 16, however, continues. Various information, such as information related to the bicycle, can therefore be acquired from the communication terminal 2a regardless of power transmission, thereby allowing the bicycle 2 to be managed after completion of charging.

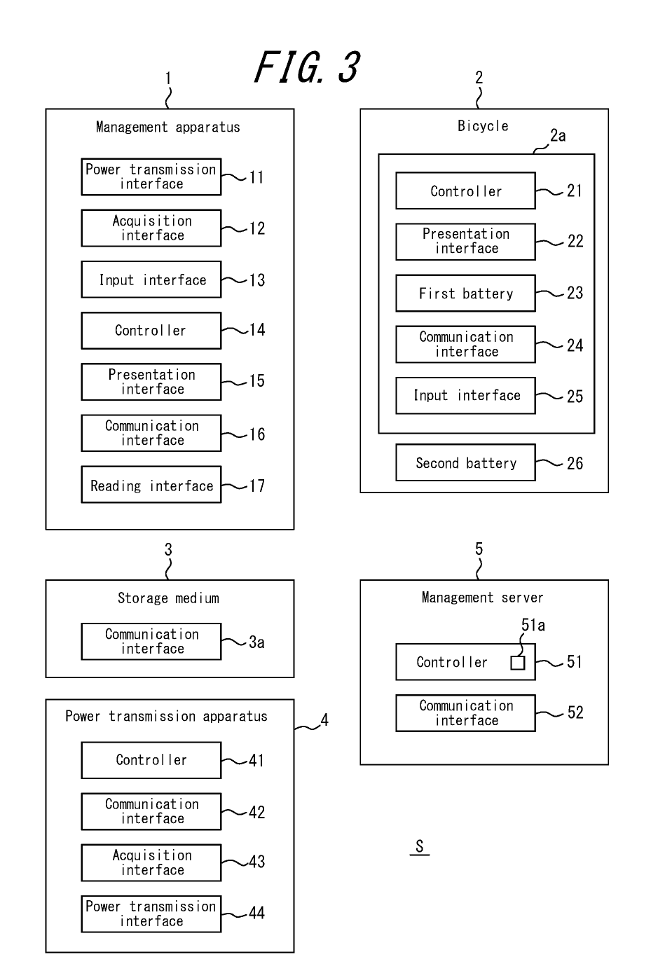

FIG. 3 is a functional block diagram of a management system S. The management system S includes the management apparatus 1, the bicycle 2, the storage medium 3, a power transmission apparatus 4, and a management server 5.

The management apparatus 1 includes the power transmission interface 11, an acquisition interface 12, an input interface 13, a controller 14, the presentation interface 15, the communication interface 16, and a reading interface 17.

The power transmission interface 11 wirelessly transmits power to at least one of the first battery 23 and the second battery 26. Electromagnetic induction, electromagnetic field resonance, radio wave transmission, or optical wireless power transmission, for example, may be used as the technique for transmitting power wirelessly. The power transmission interface 11 may transmit power in a wired manner to at least one of the first battery 23 and the second battery 26.

The acquisition interface 12 is an interface for acquiring battery level information from the bicycle 2 in a wired and/or wireless manner. The remaining battery level information indicates the remaining level of at least one of the first battery 23 and the second battery 26. The acquisition interface 12 outputs the remaining battery level information to the controller 14.

The input interface 13 is an input interface for receiving operation input from a user and is configured using operation buttons (operation keys), for example. The input interface 13 receives input of destination information and stopover information, for example. The input interface 13 may, for example, be configured by a touchscreen. The input interface 13 may receive operation input by the user via a user interface in the user's possession.

The controller 14 includes one or more processors. The controller 14 or the processor may include one or more memories that store programs for various processing and store information during calculations. The term “memory” encompasses volatile memory and non-volatile memory. The memory may be configured as a memory independent from the processor and/or a memory built into the processor. The term “processor” encompasses universal processors that execute particular functions by reading particular programs and dedicated processors that are specialized for particular processing.

Based on the destination information, the stopover information, and the remaining battery level information, for example, the controller 14 of the present embodiment identifies a bicycle 2 to rent to a user. Details are provided below.

The presentation interface 15 includes a display device such as a liquid crystal display, an organic electro luminescence (EL) display, an inorganic EL display, or the like. The presentation interface 15 may be provided with a light source or light-emitting element used as a backlight. The presentation interface 15 displays a variety of information, such as characters, symbols, images, images of objects for operation (icons), and the like to the user operating the management apparatus 1. The presentation interface 15 may be configured as a speaker and may notify the user of rentable bicycles 2 or the like by audio.

The communication interface 16 is an interface for transmitting and receiving information to and from the management server 5 or the like in a wired and/or wireless manner.

The reading interface 17 is a reader/writer capable of contactless communication with an integrated circuit (IC) card, for example, and is an interface for acquiring user information from the storage medium 3 when the storage medium 3 is in contact or in close proximity.

As described above, the bicycle 2 includes the controller 21, the presentation interface 22, the first battery 23, the communication interface 24, the input interface 25, and the second battery 26.

The controller 21 notifies the management apparatus 1 of the remaining level of at least one of the first battery 23 and the second battery 26 during parking in the bicycle parking facility. Since the hardware configuration of the controller 21 is similar to the above-described hardware configuration of the controller 14, further description is omitted.

Since the hardware configuration of the presentation interface 22 is also similar to the above-described hardware configuration of the presentation interface 15, further description is omitted.

The first battery 23 is a secondary battery that charges by receiving power supplied from the power transmission interface 11.

The communication interface 24 is an interface for transmitting and receiving information over a network to and from the management apparatus 1, any server, or any terminal apparatus.

Since the hardware configuration of the input interface 25 is similar to the above-described hardware configuration of the input interface 13, further description is omitted.

Since the hardware configuration of the second battery 26 is also similar to the above-described hardware configuration of the first battery 23, further description is omitted.

The storage medium 3 of the present embodiment is a membership card of a power transmission facility. An example of the power transmission facility is a cafe. The power transmission apparatus 4 is installed in the power transmission facility. The storage medium 3 includes a memory. The memory stores user information. The storage medium 3 further includes a communication interface 3a and can, for example, transmit the user information and the like stored in the memory to an external destination.

The power transmission apparatus 4 includes a controller 41, a communication interface 42, an acquisition interface 43, and a power transmission interface 44.

Since the hardware configurations of the controller 41, the communication interface 42, and the power transmission interface 44 are respectively similar to the hardware configurations of the controller 14, the communication interface 16, and the power transmission interface 11, further description is omitted.

The acquisition interface 43 acquires communication terminal information from a communication terminal 2a located within a predetermined range from the power transmission apparatus 4. The communication terminal information is, for example, a media access control (MAC) address. The acquisition interface 43 transmits the acquired communication terminal information to the controller 41.

The management server 5 can transmit and receive any information to and from the management apparatus 1, the bicycle 2, the power transmission apparatus 4, and the like over any network, such as the Internet. The management server 5 of the present embodiment is provided in a different location than the location where the management apparatus 1 and the power transmission apparatus 4 are installed, such as a management office of the management company that manages the bicycle parking facilities. When a plurality of management apparatuses 1 and power transmission apparatuses 4 are provided, the management server 5 can transmit and receive any information to and from the management apparatuses 1 and the power transmission apparatuses 4 and can control the management apparatuses 1 and the power transmission apparatuses 4.

The management server 5 includes a controller 51 and a communication interface 52. The controller 51 includes a memory 51a. Since the hardware configurations of the controller 51 and the communication interface 52 are respectively similar to the hardware configurations of the controller 41 and the communication interface 42, further description is omitted.

The control method executed by the management system S of the present embodiment is now described in detail. As an example, the bicycle parking facility where the user borrows the bicycle 2 is referred to as the departure bicycle parking facility, and the bicycle parking facility where the user returns the bicycle 2 is referred to as the return bicycle parking facility.

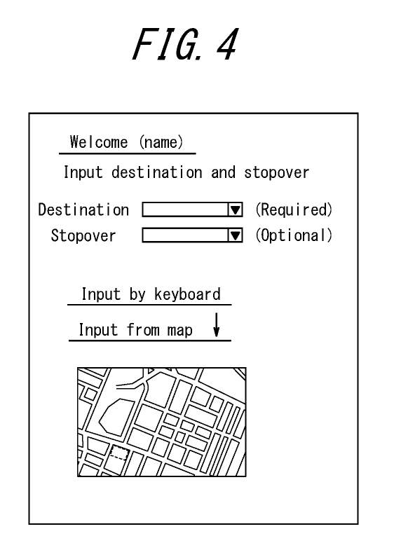

A user wishing to borrow a bicycle 2 visits the departure bicycle parking facility while carrying the storage medium 3, as illustrated in FIG. 1. At the departure bicycle parking facility, the user places the storage medium 3 in contact with or in close proximity to the reading interface 17 of the management apparatus 1. The reading interface 17 reads the user information from the storage medium 3 at this time and transmits the user information to the controller 14. After user authentication, the controller 14 displays the image in FIG. 4 on the presentation interface 15.

The presentation interface 15 displays a prompt for input of a destination and a stopover, as illustrated in FIG. 4. In the present embodiment, input of the destination is required. Input of the stopover is optional. The destination may be any location, regardless of whether the bicycle 2 can be returned. The stopover and the destination in the present embodiment are different locations from the return bicycle parking facility. For example, the stopover is a post office, and the destination is a supermarket. The destination and the stopover can be identified by user input of the name, address, latitude and longitude, or the like.

As illustrated in FIG. 4, the destination and the stopover may be selectable from pulldown menus. The destination and the stopover may be inputtable using a keyboard or a map. In the example described in the present embodiment, both the destination and the stopover are selected.

The controller 14 sets the closest bicycle parking facility to the input destination as the return bicycle parking facility. The return bicycle parking facility may be settable by the user. The expected time of arrival at the return bicycle parking facility may also be settable.

The controller 14 calculates the distance from the current location, i.e. the departure bicycle parking facility, to the return bicycle parking facility via the stopover and the destination. The controller 14 calculates a threshold of the remaining battery level necessary to reach the return bicycle parking facility from the current location, taking into account the calculated distance and the difference in elevation from the current location to the return bicycle parking facility. The threshold of the necessary remaining battery level may be calculated by also taking into account the current time and the estimated time of arrival at the return bicycle parking facility. For the sake of explanation, the remaining battery level is the remaining level of the first battery 23 in the present embodiment but may be the remaining level of the second battery 26 instead.

The threshold calculated by the controller 14 may be the minimum remaining battery level necessary to reach the return bicycle parking facility from the current location. The threshold may instead be set to a value with a margin by adding a predetermined value to the minimum necessary value.

The controller 14 determines whether any bicycles 2 among one or more bicycles 2 parked at the departure bicycle parking facility have the necessary remaining battery level that was calculated.

When the controller 14 determines that no bicycle 2 has the necessary remaining battery level, the controller 14 executes the following processing. The controller 14 acquires the remaining battery level information of each bicycle 2 parked at a bicycle parking facility along the route from the departure bicycle parking facility to the stopover or destination, or within a predetermined distance from the route, from the management apparatus 1 of the bicycle parking facility. In the present embodiment, this bicycle parking facility is referred to as a transfer bicycle parking facility. The controller 14 identifies, from among the acquired remaining battery level information, a bicycle 2 that has the necessary remaining battery level to reach the return bicycle parking facility from the transfer bicycle parking facility via the stopover and the destination. The controller 14 causes the presentation interface 15 to display position information, such as a map and address, of the transfer bicycle parking facility where the identified bicycle 2 is parked. The controller 14 identifies bicycles 2 having the necessary battery to reach the transfer bicycle parking facility from among the bicycles 2 parked at the departure bicycle parking facility and causes the presentation interface 15 to display an indication to travel to the transfer bicycle parking facility using one of the identified bicycles 2. The controller 14 then unlocks the bicycle 2 selected by the user from among the displayed bicycles 2 and rents out the bicycle 2.

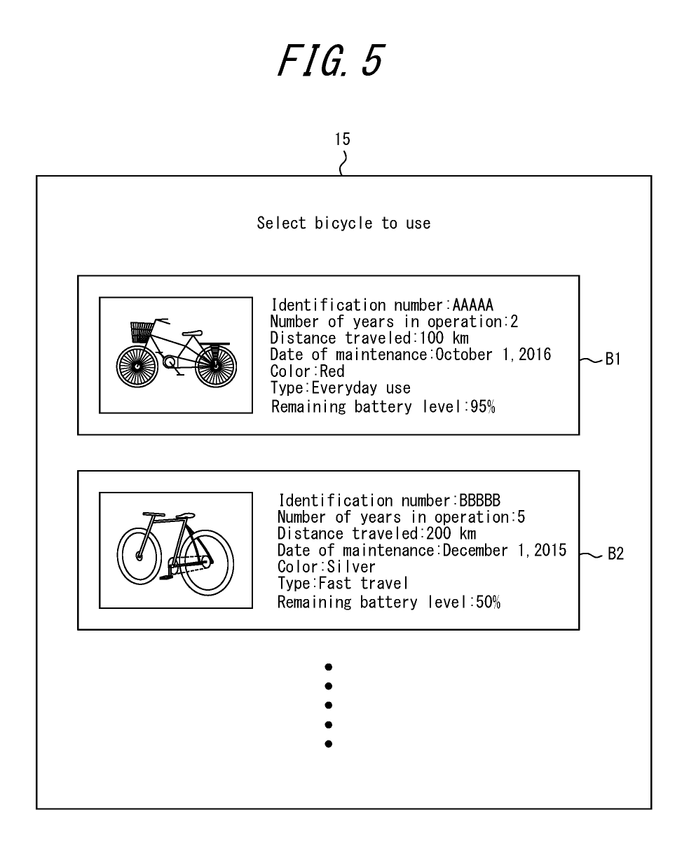

On the other hand, when the controller 14 determines that a bicycle 2 does have the necessary remaining battery level, the controller 14 identifies a plurality of pieces of information related to each bicycle 2 from the memory of the management apparatus 1 and causes the presentation interface 15 to display the information selectably as information B1 and B2, as illustrated in FIG. 5. The information related to the bicycle may, for example, include at least one of an exterior image of the bicycle, identification number, number of years in operation, distance traveled, date of maintenance, color and type (everyday use, fast travel, or the like), remaining battery level [%], travel range, estimated operating time calculated from the remaining battery level, and number of charge/discharge cycles of the battery. The pieces of information related to the bicycle are stored in association in the memory of the management apparatus 1. The presentation interface 15 at this time displays the bicycle 2 with the largest remaining battery level (95%) at the top and the bicycle 2 with the next largest remaining battery level (50%) below the top bicycle 2. In other words, the presentation interface 15 presents the bicycles 2 from the top in descending order of remaining battery level. The presentation interface 15 at this time may display the information B1 and information B2 with different background colors to make the bicycles 2 easier to distinguish.

The user selects the exterior image of the bicycle 2 that the user wishes to borrow from among the exterior images of bicycles 2 displayed by the presentation interface 15. When the controller 14 receives a selection operation by the user via the input interface 13, the controller 14 releases the lock of the selected bicycle 2 and rents out the bicycle 2.

Once the bicycle 2 is rented out, the controller 14 determines whether the user is authorized to have the bicycle 2 receive power transmission based on the user information read from the storage medium 3. Specifically, the controller 14 determines whether the user is a member of a predetermined power transmission facility, whether the user's frequency of use of the power transmission facility is equal to or greater than a threshold, or whether the telephone number included in the user information is registered in a predetermined server of a power transmission facility.

When the controller 14 determines that the user is authorized to have the bicycle 2 receive power transmission, the controller 14 accesses the management server 5. The controller 14 registers communication terminal information of the communication terminal 2a of the identified bicycle 2 in a power transmission authorized list stored in the management server 5 to update the power transmission authorized list. The bicycle 2 is thereby stored in the memory 51a as a target for receipt of power transmission by radio waves. On the other hand, when the controller 14 determines that the user is not authorized to have the bicycle 2 receive power transmission, the controller 14 does not register the communication terminal information of the communication terminal 2a of the bicycle 2 rented to the user in the power transmission authorized list.

The controller 51 of the management server 5 outputs the updated power transmission authorized list to one or more power transmission apparatuses 4. When the power transmission apparatus 4 acquires the power transmission authorized list, the acquisition interface 43 is controlled by the controller 41 to periodically or irregularly acquire the communication terminal information of the communication terminal 2a of all bicycles 2 parked in the power transmission range of the power transmission interface 44. The power transmission range is, for example, a range that includes a bicycle parking lot of the power transmission facility. The controller 41 determines whether the communication terminal information of the communication terminal 2a is registered in the power transmission authorized list. The processing after this determination is described below in detail.

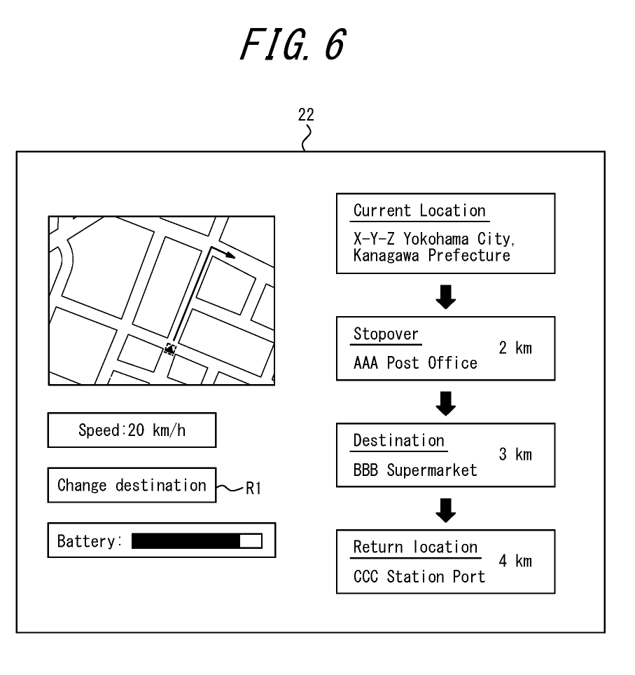

The controller 21 of the bicycle 2 acquires the stopover information and the destination information, respectively corresponding to the stopover and the destination inputted by the user, from the management apparatus 1 via the communication interface 24. The controller 21 provides directions, on the presentation interface 22, from the current location to the return bicycle parking facility via the stopover and the destination. The image displayed by the presentation interface 22 at this time is illustrated in FIG. 6. The controller 21 may determine the current location based on global positioning system (GPS) information. When the bicycle 2 can receive power by radio wave transmission, the controller 21 may determine the current location based on information acquired by using radio waves from a radio wave power transmission device near the bicycle 2. The controller 21 may provide directions by audio using the speaker.

When the controller 21 determines that the bicycle 2 has reached the stopover, the controller 21 provides directions to the destination.

While providing directions, the controller 21 can receive a change in destination through the input interface 25 by a selection operation on a region R1 included in the image displayed in FIG. 6 or by voice input. When the controller 21 receives a change in destination from the user, the controller 21 calculates a threshold of the remaining battery level necessary to reach the return bicycle parking facility based on current location information and the destination information.

The controller 21 determines whether the first battery 23 has the necessary remaining battery level that was calculated. When the controller 21 determines that the first battery 23 does not have the necessary remaining battery level, the controller 21 provides notification that the remaining battery level is insufficient via display on the presentation interface 22 or via the speaker. The controller 21 presents the following options on the presentation interface 22.
(a) Go directly from the current location to the new destination, even though the first battery 23 will run out before the bicycle 2 reaches the return bicycle parking facility.
(b) Switch to a different bicycle at a bicycle parking facility near the route from the current location to the new destination.
(c) Rest at a power transmission facility where the first battery 23 can receive power, such as a cafe, and have the first battery 23 receive high output power from the power transmission apparatus 4 installed in the power transmission facility.

When option (a) is selected, the controller 21 provides directions to the new destination. When the controller 21 determines that the bicycle 2 has reached the new destination, the controller 21 provides directions to the return bicycle parking facility.

When option (b) is selected, the controller 21 provides directions to a bicycle parking facility near the route from the current location to the new destination. The controller 21 accesses the management apparatus 1 at the bicycle parking facility and reserves the bicycle to which the user will switch, so that the bicycle is not rented to another user. In the present embodiment, this bicycle parking facility is referred to as a reserved bicycle parking facility. When the controller 21 determines that the bicycle 2 currently in use has reached the reserved bicycle parking facility, the controller 21 causes the presentation interface 22 to display an instruction to return the bicycle 2. The management apparatus 1 at the reserved bicycle parking facility causes the presentation interface 15 to display an indication to use the reserved bicycle 2. The user uses the reserved bicycle 2. The controller 21 of the bicycle 2 newly in use provides directions to the destination. When the controller 21 determines that the bicycle 2 has reached the new destination, the controller 21 provides directions to the return bicycle parking facility.

When option (c) is selected, the controller 21 provides directions to the power transmission facility. The controller 21 may cause the presentation interface 22 to display information related to the power transmission facility, including coupons usable at the facility, advertising information for the facility, or the like. Information related to a plurality of power transmission facilities may be displayed for the user to select a power transmission facility. Information related to the power transmission facility may be transmitted from the controller 21 via the communication interface 24 to an external communication device in the user's possession. The conditions when the bicycle 2 reaches the power transmission facility are described below.

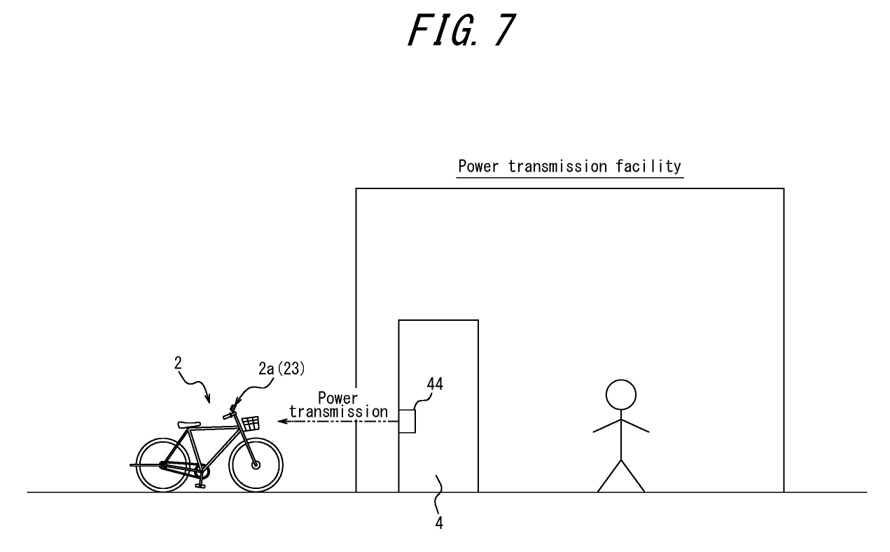

As described above, the controller 41 determines whether the communication terminal information of the communication terminal 2a is registered in the power transmission authorized list. When the controller 41 determines that the communication terminal information of the communication terminal 2a is registered, the power transmission interface 44 transmits power to the bicycle 2 that includes the communication terminal 2a, as illustrated in FIG. 7. The first battery 23 is thereby charged.

The controller 21 may calculate a threshold of the remaining battery level necessary to reach the return bicycle parking facility from the power transmission facility via the destination. In this case, the controller 21 may calculate the required time for charging up to the necessary remaining battery level and cause the presentation interface 22 to display the required time. When the user's rest at the power transmission facility ends and use of the bicycle 2 begins again, the controller 21 provides directions to the return bicycle parking facility via the destination.

As an example in the present embodiment, a service to rent the power transmission apparatus 4 at the power transmission facility and a service to supply power to the power transmission facility are offered from the same supply source. Therefore, the controller 41 periodically or irregularly measures the power consumed for power transmission to the communication terminal 2a and stores the measurement result in memory. The extra electric bill due to power transmission can thus be calculated to compensate the supply source for the electric bill.

When the bicycle 2 is returned to the return bicycle parking facility, the controller 14 of the management apparatus 1 installed in the return bicycle parking facility accesses the management server 5 and removes the communication terminal information of the communication terminal 2a of the returned bicycle 2 from the power transmission authorized list. When the bicycle 2 is returned, the controller 14 may instead store the bicycle 2 in the memory 51a of the controller 51 as a target to which power should not be transmitted by radio waves.

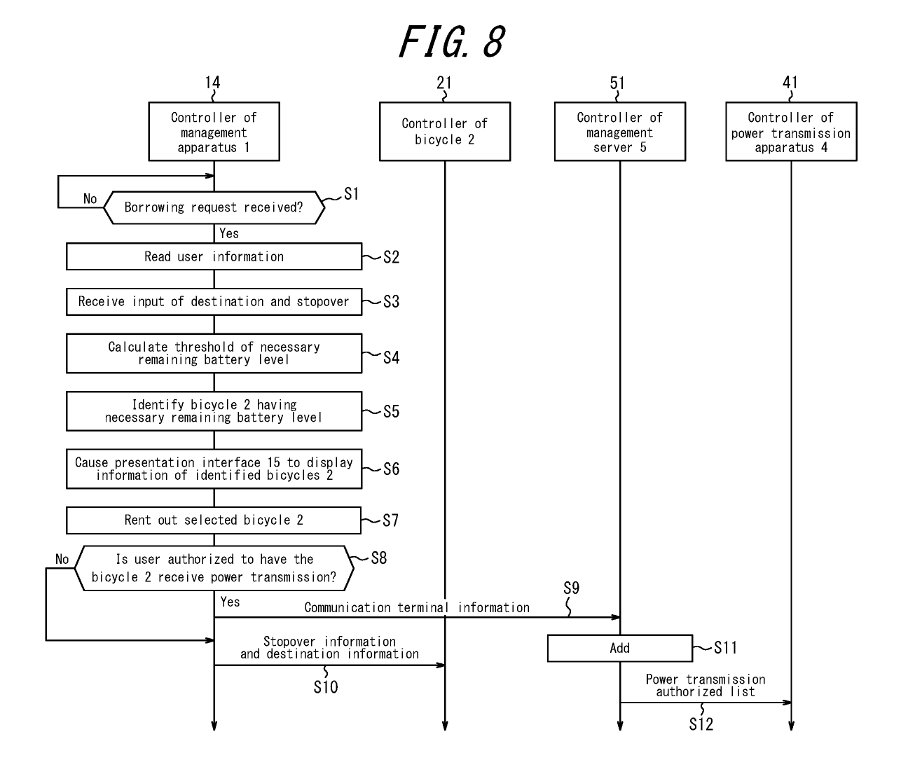

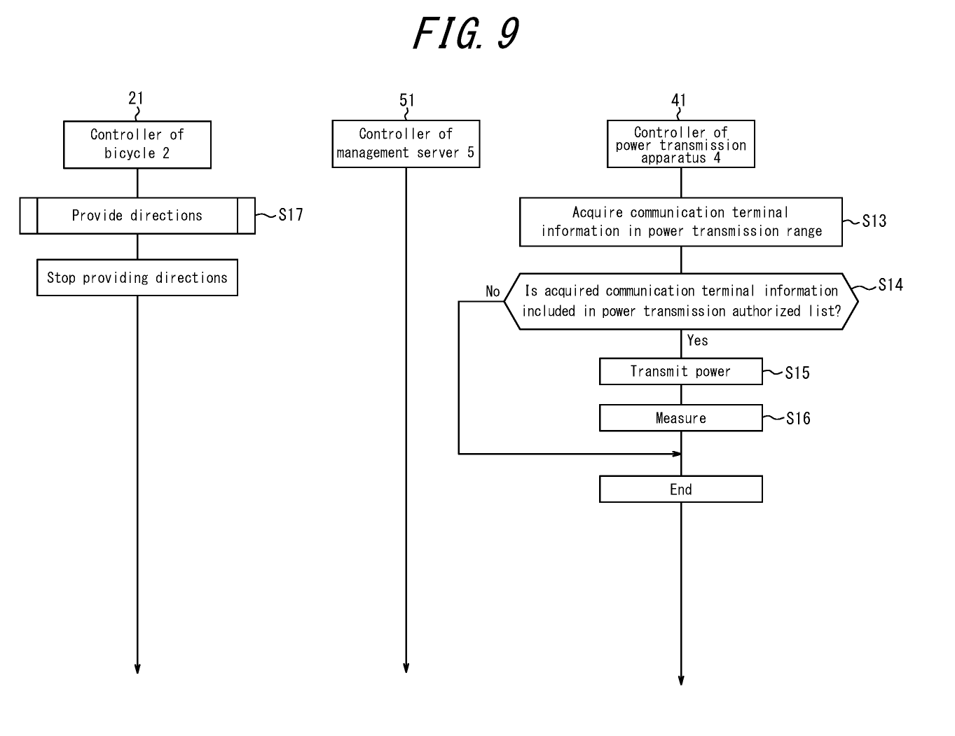

FIG. 8 and FIG. 9 are sequence diagrams of processing executed by the controller 14 of the management apparatus 1, the controller 21 of the bicycle 2, the controller 51 of the management server 5, and the controller 41 of the power transmission apparatus 4.

As illustrated in FIG. 8, the controller 14 determines in step S1 whether a request to borrow a bicycle 2 has been received from the user. When the determination result of step S1 is Yes, then in step S2, the controller 14 reads user information from the storage medium 3 in contact with or in close proximity to the reading interface 17. In step S3, the controller 14 receives input of the destination and the stopover. In step S4, the controller 14 calculates a threshold of the remaining battery level necessary to reach the return bicycle parking facility via the stopover and the destination. In step S5, the controller 14 identifies, from among the bicycles 2 parked at the departure bicycle parking facility, bicycles 2 that have the necessary remaining battery level. In step S6, the controller 14 causes the presentation interface 22 to display the bicycles 2 identified in step S5.

In step S7, the controller 14 rents out the bicycle 2 selected by the user. In step S8, the controller 14 determines whether the user is authorized to have the bicycle receive power transmission. When the determination result of step S8 is Yes, then in step S9, the controller 14 transmits the communication terminal information of the communication terminal 2a of the bicycle 2 rented to the user to the management server 5. In step S10, the controller 14 transmits the stopover information and the destination information, respectively corresponding to the inputted stopover and destination, to the bicycle 2. When the determination result of step S8 is No, the controller 14 executes step S10 without executing step S9.

When the controller 51 receives the communication terminal information, the controller 51 adds the communication terminal information to the power transmission authorized list in step S11. The controller 51 transmits the power transmission authorized list to the power transmission apparatus 4 in step S12.

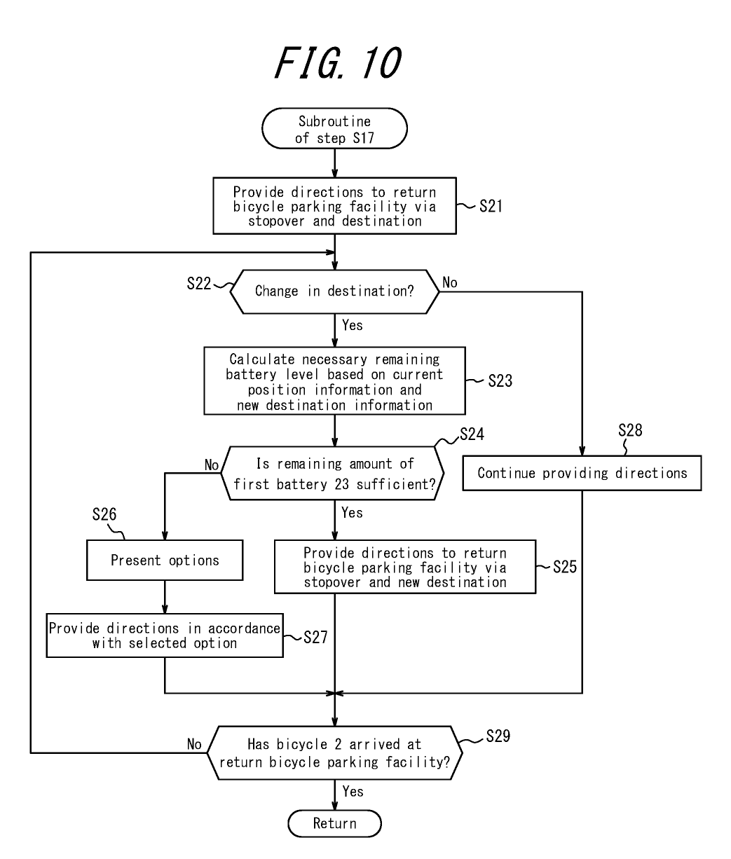

As illustrated in FIG. 9, the controller 21 provides directions in step S17. Details of the directions in step S17 are described below with reference to FIG. 10. When the bicycle 2 reaches the return bicycle parking facility, the controller 21 stops providing directions.

In step S13, the controller 41 of the power transmission apparatus 4 acquires the communication terminal information of a communication terminal 2a located within the power transmission range of the power transmission interface 44. In step S14, the controller 41 determines whether the acquired communication terminal information is included in the power transmission authorized list. When the determination result of step S14 is Yes, then in step S15, the controller 41 transmits power to the communication terminal 2a corresponding to the communication terminal information included in the power transmission authorized list. In step S16, the controller 41 measures the power consumed for power transmission and ends power transmission.

On the other hand, when the determination result of step S14 is No, the controller 41 ends the processing without executing step S15 and step S16.

FIG. 10 illustrates the subroutine in step S17 of FIG. 9.

In step S21, the controller 21 provides directions to the return bicycle parking facility via the stopover and the destination. In step S22, the controller 21 determines whether the destination was changed. When the determination result of step S22 is Yes, then in step S23, the controller 21 calculates the necessary remaining battery level based on the current location information and the new destination information.

In step S24, the controller 21 determines whether the remaining level of the first battery 23 is sufficient compared to the remaining battery level calculated in step S23. When the determination result of step S24 is Yes, then in step S25, the controller 21 provides directions to the return bicycle parking facility via the stopover and the new destination.

Conversely, when the determination result of step S24 is No, the controller 21 presents options in step S26. In step S27, the controller 21 provides directions corresponding to the selected option. Details of the options are as described above. Hence, further description is omitted.

When the determination result of step S22 is No, the controller 21 continues to provide directions in step S28.

In step S29, the controller 21 determines whether the bicycle 2 has reached the return bicycle parking facility. When the determination result of step S29 is Yes, the subroutine returns. The controller 21 then stops providing directions. Conversely, when the determination result of step S29 is No, the controller 21 executes step S22.

In the present embodiment, the controller 14 identifies bicycles 2 based on the destination information and the remaining battery level information. The presentation interface 15 presents the identified bicycles 2. This configuration can reduce the risk of the first battery 23 running out while the user is using the bicycle 2, particularly in cases such as when long distance travel is expected, thereby solving one of the problems with cycle sharing. User convenience can thus be increased.

In the present embodiment, the input interface 13 receives input of a stopover. The controller 14 identifies bicycles 2 based on the destination information and the stopover information. This configuration can reduce the risk of the battery running out when the user travels to the destination via a stopover and can therefore further increase user convenience.

In the present embodiment, the presentation interface 15 presents information related to the identified bicycles 2. Users can therefore select bicycles 2 matching their preferences when various types of bicycles 2 exist, increasing user convenience.

When it is determined, based on the destination information and the remaining battery level information, that no bicycles 2 parked at a first bicycle parking facility can be identified in the present embodiment, the acquisition interface 12 further acquires the remaining battery level information of bicycles parked at a second bicycle parking facility. The first bicycle parking facility corresponds to the departure bicycle parking facility. The second bicycle parking facility corresponds to the transfer bicycle parking facility. The presentation interface 15 provides an instruction to travel to the second bicycle parking facility. Therefore, the needs of a user who wishes to use the bicycle 2 immediately can be fulfilled.

When the controller 21 determines that the remaining battery level is insufficient in the present embodiment, the communication interface 24 transmits predetermined information to an external communication device. The predetermined information includes at least information related to a power transmission facility that can supply power to the first battery 23. The information related to the power transmission facility includes, for example, coupons usable at the facility or advertising information of the facility. This information is helpful for using coupons in the facility or recognizing advertising information when the user reaches the power transition facility on the bicycle 2, dismounts from the bicycle 2, and enters the power transmission facility while carrying the communication device. User convenience is therefore improved.

In the present embodiment, the bicycle 2 of a user who is authorized to have the bicycle 2 receive power transmission, such as a member of a power transmission facility, can receive power transmission at the power transmission facility. Accordingly, the user of the bicycle 2 can be encouraged to visit the power transmission facility to charge the first battery 23. A highly convenient system that can increase the number of customers visiting the power transmission facility can thus be provided. A user not authorized to have the bicycle 2 receive power transmission, however, such as a nonmember of the power transmission facility, might visit the power transmission facility only to charge the battery, without intending to buy any merchandise or the like. The controller 41 in the present embodiment does not transmit power to the communication terminal 2a of the bicycle 2 of a user who is not authorized to have the bicycle 2 receive power transmission, thereby reducing useless power consumption for power transmission in the power transmission facility.

When the controller 14 determines that the user is authorized to have the bicycle 2 receive power transmission in the present embodiment, the memory 51a stores the bicycle 2 as a target for receipt of power transmission by radio waves. When the bicycle 2 is returned, the memory 51a stores the bicycle 2 as a target to which power should not be transmitted by radio waves. Therefore, even when a plurality of bicycles 2 are rented, for example, it is easy to identify whether each bicycle 2 is a target for receipt of power reception by radio waves.

Although an embodiment has been described based on examples and drawings, it is to be noted that various changes and modifications will be apparent to those skilled in the art based on the present disclosure. Therefore, such changes and modifications are to be understood as included within the scope of the embodiment. For example, the functions and the like included in the various members, units, steps, and the like may be reordered in any logically consistent way. When embodying a method as well, units or steps may be combined into one or divided.

### Second Embodiment

In the second embodiment, the controller 14 determines whether power transmission can be received at the destination.

When the controller 14 determines that the destination is a location where power supply by radio waves can be received, the controller 14 identifies bicycles that at least have the necessary remaining battery level to travel the distance from the departure bicycle parking facility to the destination. The processing of the management apparatus 1 from causing the presentation interface 22 to display the identified bicycles 2 onward is similar to the first embodiment. Hence, further description is omitted. The controller 14 makes the determination of whether the destination is a location where power supply by radio waves can be received by, for example, communicating with a server on the Internet. The server stores position information of radio wave power transmission devices that transmit power by radio waves. The controller 14 communicates with the server, and when the destination is included in a predetermined range from the acquired position information of a radio wave power transmission device, the controller 14 may determine that the destination is a location where power supply by radio waves can be received. The predetermined range is, for example, 12 m or less.

The controller 14 in the present embodiment determines whether the destination is a location where power supply by radio waves can be received. When the controller 14 determines that the destination is a location where power supply by radio waves can be received, the controller 14 identifies bicycles 2 based on the distance to the destination. When the destination is a location where power supply by radio waves can be received, power transmission to the first battery 23 can be received at the destination. The remaining battery level necessary to reach the return bicycle parking facility from the destination can thus be ensured. Accordingly, bicycles 2 that do not have the remaining battery level for reaching the return bicycle parking facility but do have the remaining battery level to reach the destination can be identified as bicycles 2 to rent out. The range of choices for the user thus expands, improving user convenience.

Similarly, when the controller 14 receives input of the stopover as in the first embodiment, the controller 14 may determine whether power transmission can be received at the stopover. When the controller 14 determines that the stopover is a location where power transmission can be received, the controller 14 identifies bicycles 2 that have at least the remaining battery level necessary to reach the stopover from the departure bicycle parking facility. The processing of the management apparatus 1 from causing the presentation interface 22 to display the identified bicycles 2 onward is similar to the first embodiment. Hence, further description is omitted.

### Third Embodiment

In the first embodiment, the controller 14 causes the presentation interface 22 to display an indication to travel to the transfer bicycle parking facility when the controller 14 determines that no bicycle 2 has the necessary remaining battery level that was calculated. The controller 14 of the third embodiment, on the other hand, causes the presentation interface 22 to display an indication to wait at the departure bicycle parking facility when the controller 14 determines that no bicycle 2 has the necessary remaining battery level. The first batteries 23 of the bicycles 2 parked at the departure bicycle parking facility are charged while the user is waiting. When any one of the bicycles 2 is charged to the necessary remaining battery level, the controller 14 causes the presentation interface 22 to display a corresponding indication. The controller 14 rents out the bicycle 2 that was charged to the necessary remaining battery level.

### Fourth Embodiment

In the first embodiment, the controller 21 of the bicycle 2 provides directions to the return bicycle parking facility via the stopover and the destination. In other words, the user uses the bicycle 2 until reaching the return bicycle parking facility. In the fourth embodiment, the controller 21 of the bicycle 2 provides directions to the closest return bicycle parking facility to the destination via the stopover. In other words, the user uses the bicycle until reaching the return bicycle parking facility closest to the destination and travels to the destination from there on foot or the like.

### Fifth Embodiment

In the first embodiment, the controller 21 of the bicycle 2 provides notification that the remaining battery level is insufficient when judging that the first battery 23 does not have the necessary remaining battery level. When the controller 21 of the bicycle 2 in the fifth embodiment determines that the first battery 23 does not have the necessary remaining battery level, the controller 21 estimates the remaining time until the first battery 23 runs out and causes the presentation interface 22 to display the remaining time. The controller 21 of the bicycle 2 may provide notification of the remaining time via the speaker. The controller 21 may cause the presentation interface 22 to display the remaining time until the first battery 23 runs out along with options (a) to (c) described in the first embodiment. User convenience is thus improved.

When the user has set the estimated time of arrival at the return bicycle parking facility, the controller 21 may cause the presentation interface 22 to display the length of time from the current time until the estimated time of arrival.

### Sixth Embodiment

In the first embodiment, the storage medium 3 is a membership card of a predetermined cafe. In the sixth embodiment, however, the storage medium 3 is a mobile terminal. The mobile terminal may be any terminal apparatus, such as a smartphone, a feature phone, a PC, or a tablet PC. To determine whether the user is authorized to have the bicycle receive power transmission in this case, the controller 14 of the management apparatus 1 may determine whether an ID assigned to the mobile terminal by the carrier of the mobile terminal matches a predetermined ID.

### Seventh Embodiment

The storage medium 3 of the first embodiment is a membership card of a predetermined cafe. The storage medium 3 of the seventh embodiment, however, is a mobile terminal as in the sixth embodiment. Furthermore, the controller 41 of the power transmission apparatus 4 in the seventh embodiment determines whether the user is authorized to have the bicycle receive power transmission in the below-described way, based on communication terminal information stored by the mobile terminal. The controller 41 corresponds to the second controller. A description of matter overlapping with the first embodiment is omitted.

A user who wishes to borrow a bicycle 2 does so by placing a contactless IC chip near the reading interface 17 of the management apparatus 1. The IC chip is built into the mobile storage medium 3, i.e. the mobile terminal. When the management apparatus 1 identifies a bicycle 2 to rent to the user, the management apparatus 1 transmits the communication terminal information of the communication terminal 2a of the bicycle 2 to the storage medium 3. The storage medium 3 stores the communication terminal information.

When the user visits a power transmission facility using the bicycle 2 and purchases merchandise at the power transmission facility, the user pays with electronic money stored on the storage medium 3. The power transmission apparatus 4 acquires at this time the communication terminal information stored on the storage medium 3 directly from the communication interface 3a of the storage medium 3 or indirectly via a terminal for payment by electronic money. The controller 41 uses the communication terminal information to determine that the user is authorized to have the bicycle receive power transmission. The power transmission interface 44 of the power transmission apparatus 4 transmits power to the communication terminal 2a corresponding to the acquired communication terminal information.

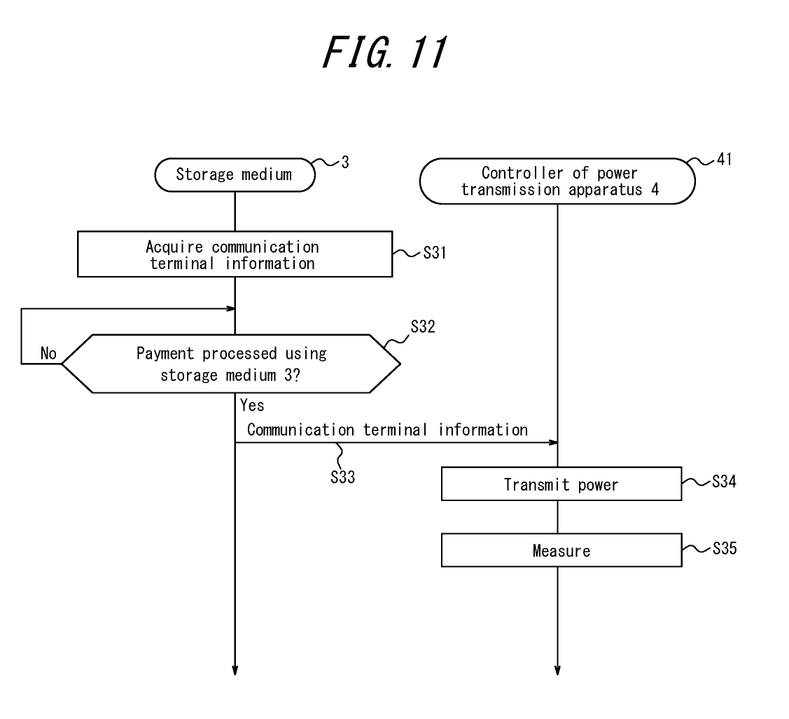

FIG. 11 is a sequence diagram illustrating processing executed by a management system S in the present embodiment.

In step 31, when the storage medium 3 is placed in contact with or in close proximity to the reading interface 17, the storage medium 3 acquires the communication terminal information of the communication terminal 2a of the bicycle 2 to be lent to the user from the management apparatus 1. In step S32, the storage medium 3 determines whether payment has been processed using the storage medium 3. When the determination result of step S32 is Yes, the storage medium 3 transmits the communication terminal information to the power transmission apparatus 4 in step S33.

In step S34, the controller 41 of the power transmission apparatus 4 transmits power to the communication terminal 2a corresponding to the received communication terminal information. In step S35, the controller 41 measures the power consumed for power transmission.

By the performance of two procedures with the same storage medium 3, i.e. the procedure to borrow the bicycle 2 and the payment procedure at the power transmission facility, the present embodiment associates the user and the bicycle 2 and allows charging. The determination of whether the user is authorized to have the bicycle 2 receive power transmission can be made by the power transmission apparatus 4 at the power transmission facility, eliminating the need for determination by a server or the like external to the power transmission facility.

### Eighth Embodiment

The controller 14 of the management apparatus 1 in the first embodiment determines, during the processing to rent out the bicycle 2, whether the user is authorized to have the bicycle receive power transmission based on the user information acquired from the storage medium 3. During the processing to rent out the bicycle 2 in the eighth embodiment, the controller 14 transmits a security key to the communication terminal 2a of the bicycle 2 for performing authentication with the power transmission interface 44 as described below.

At the departure bicycle parking facility, the user wishing to borrow a bicycle 2 places the storage medium 3 in the user's possession in contact with or in close proximity to the reading interface 17 of the management apparatus 1. The controller 14 of the management apparatus 1 acquires the user information from the storage medium 3 via the reading interface 17 at this time.

The controller 14 of the management apparatus 1 rents out the bicycle 2 to the user and also determines, based on the user information, whether the user is authorized to have the bicycle 2 receive power transmission. When the controller 14 determines that the user is authorized to have the bicycle 2 receive power transmission, the controller 14 transmits an electronic security key to the bicycle 2 being rented out to the user. The security key is necessary for connecting to the power transmission apparatus 4.

The user heads towards the power transmission facility using the bicycle 2. The controller 21 of the bicycle 2 determines, periodically or irregularly, whether the bicycle 2 has reached the power transmission apparatus 4. The controller 21 may determine that the bicycle 2 has reached the power transmission apparatus 4 using GPS information or may determine that the bicycle 2 has reached the power transmission apparatus 4 when a predetermined signal emitted by the power transmission apparatus 4 is received.

When the controller 21 determines that the bicycle 2 has reached the power transmission apparatus 4, the controller 21 transmits the security key stored in the controller 21 to the power transmission apparatus 4. The controller 41 of the power transmission apparatus 4 authenticates the bicycle 2 using the security key and determines that the user is authorized to have the bicycle 2 receive power transmission. The controller 41 controls the power transmission interface 44 to transmit power to the bicycle 2.

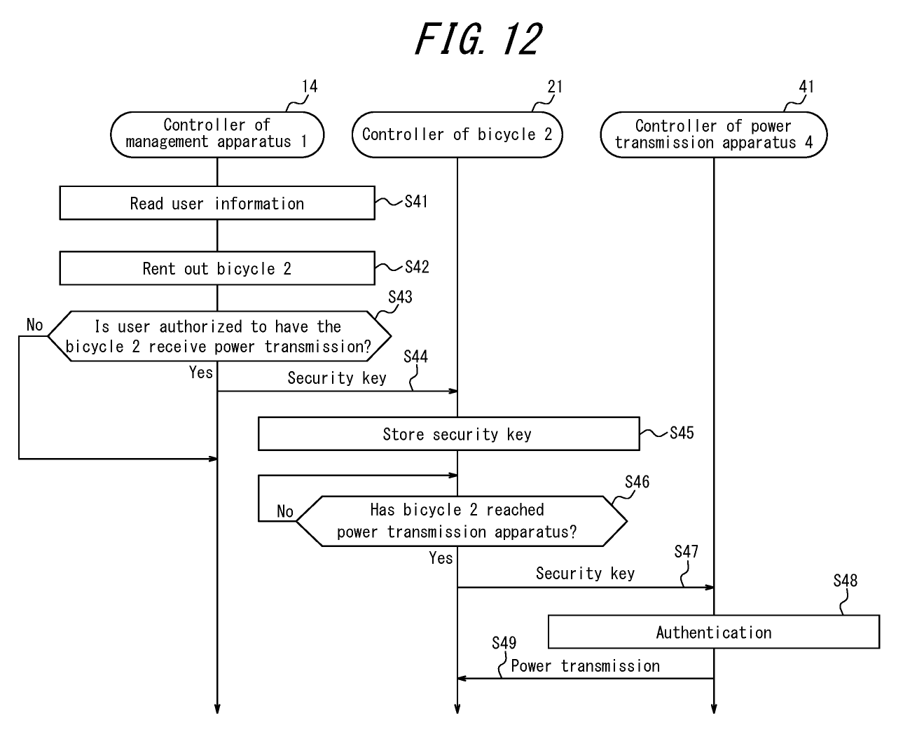

FIG. 12 is a sequence diagram illustrating processing executed by a management system S in the present embodiment.

In step S41, the controller 14 of the management apparatus 1 reads the user information via the reading interface 17. In step S42, the controller 14 identifies a bicycle 2 and rents out the bicycle 2 to the user. In step S43, the controller 14 determines whether the user is authorized to have the bicycle 2 receive power transmission. When the determination result of step S43 is No, the controller 14 terminates processing without executing step S44.

When the determination result of step S43 is Yes, the controller 14 transmits the security key to the bicycle 2 in step S44. In step S45, the controller 21 of the bicycle 2 stores the received security key in the memory of the communication terminal 2a. In step S46, the controller 21 determines whether the bicycle 2 has reached the power transmission apparatus 4. When the determination result of step S46 is Yes, the controller 21 transmits the stored security key to the power transmission apparatus 4 in step S47. In step S48, the controller 41 of the power transmission apparatus 4 authenticates the user using the received security key. In step S49, the controller 41 controls the power transmission interface 44 to transmit power to the bicycle 2 that transmitted the security key. The first battery 23 of the bicycle 2 is thus charged.

The present embodiment allows the bicycle 2 to receive power when reaching the power transmission apparatus 4 of the power transmission facility if the bicycle 2 has the security key stored therein. The processing load of the power transmission apparatus 4 at the power transmission facility can therefore be reduced, since it suffices to check for the security key in order to determine whether the user is authorized to have the bicycle 2 receive power transmission.

### Ninth Embodiment

The controller 14 of the management apparatus 1 in the first embodiment determines, during the processing to rent out the bicycle 2, whether the user is authorized to have the bicycle 2 receive power transmission based on the user information acquired from the storage medium 3. As described below, the controller 41 of the power transmission apparatus 4 in the ninth embodiment determines whether the user is authorized to have the bicycle 2 receive power transmission based on attachment identifying information acquired from an attachment attached to the communication terminal 2a.

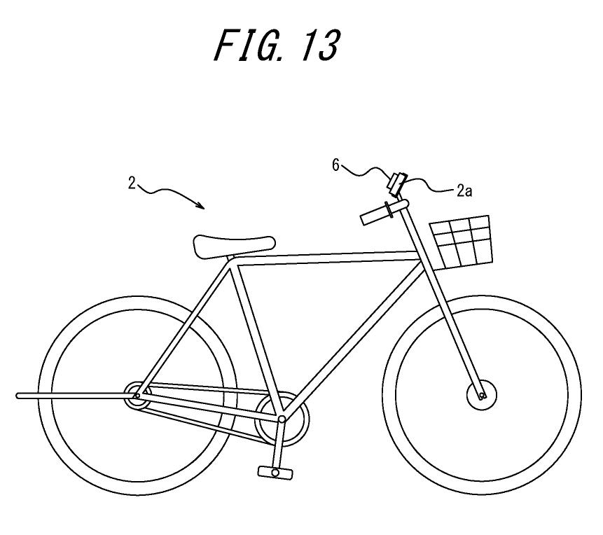

A detachable attachment 6 is attached to the communication terminal 2a of the bicycle 2 in the present embodiment, as illustrated in FIG. 13. A number is displayed on the surface of the attachment 6 as the attachment identifying information. When a user borrows the bicycle 2 at the departure bicycle parking facility and visits a power transmission facility, the user takes note of the attachment identifying information indicated on the attachment 6 and relays the attachment identifying information to the clerk when purchasing merchandise at the power transmission facility.

The clerk inputs the attachment identifying information to a predetermined terminal, such as a cash register. The terminal transmits the attachment identifying information to the power transmission apparatus 4 of the power transmission facility. In this way, the controller 41 of the power transmission apparatus 4 determines that the user is authorized to have the bicycle 2 receive power transmission and controls the power transmission interface 44 to transmit power to the attachment 6 identified by the attachment identifying information. The first battery 23 thus receives power transmission via the attachment 6 and is charged.

Instead of taking note of the attachment identifying information, the user may instead remove a physical key inserted in the attachment 6 and present the key to the clerk of the power transmission facility. In this case, the predetermined terminal of the power transmission facility, such as a cash register, reads the attachment identifying information from the presented key and transmits the attachment identifying information to the power transmission apparatus 4. The controller 41 of the power transmission apparatus 4 can thereby identify the communication terminal 2a to be targeted for power transmission.

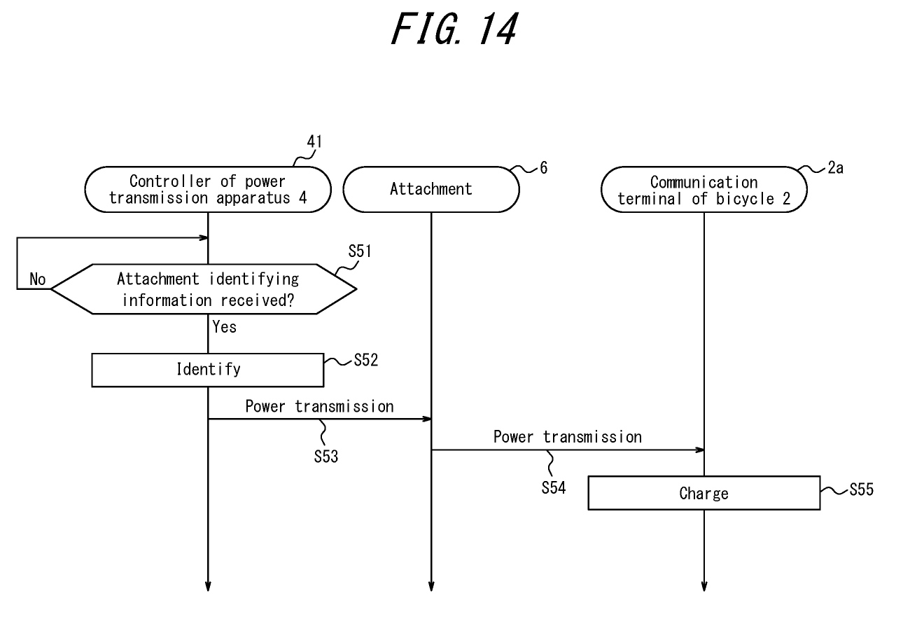

FIG. 14 is a sequence diagram illustrating processing executed by a management system S in the present embodiment.

In step S51, the controller 41 of the power transmission apparatus 4 determines whether the attachment identifying information has been received from a predetermined terminal in the power transmission facility. When the determination result of step S51 is Yes, then in step S52, the controller 41 identifies the communication terminal 2a to be targeted for power transmission based on the attachment identifying information. In steps S53 and S54, the controller 41 transmits power to the communication terminal 2a via the identified attachment 6. The communication terminal 2a is thereby charged in step S55.

### Tenth Embodiment

The management apparatus 1 of the first embodiment is provided in the bicycle parking facility. The management apparatus 1 of the tenth embodiment may, for example, be mounted between the seat of the bicycle 2 and the rear wheel. This allows a user who wishes to borrow the bicycle 2 to perform the borrowing procedure by placing the storage medium 3 in contact with or in close proximity to the reading interface 17 of the management apparatus 1 mounted on the bicycle 2.

### Eleventh Embodiment

In the first embodiment, the controller 14 of the management apparatus 1 determines whether the user is authorized to have the bicycle 2 receive power transmission. In the eleventh embodiment, the controller 14 of the management apparatus 1 transmits the user information to the management server 5, and the controller 51 of the management server 5 determines whether the user is authorized to have the bicycle 2 receive power transmission.

### Twelfth Embodiment

In the first embodiment, the controller 41 of the power transmission apparatus 4 measures the power consumed by the power transmission interface 44 for power transmission. In the twelfth embodiment, the controller 41 of the power transmission apparatus 4 transmits any appropriate information for measuring the power consumed for power transmission to the management server 5, and the controller 51 of the management server 5 measures the power consumed by the power transmission interface 44 for power transmission. The processing load and the power consumption in the power transmission apparatus 4 can be reduced in this case. The controller 51 corresponds to the third controller.

### Thirteenth Embodiment

The controller 14 of the first embodiment causes the presentation interface 15 to display bicycles 2 having the necessary remaining battery level. In the thirteenth embodiment, the controller 14 causes the presentation interface 15 to display the bicycle 2 having the maximum remaining battery level. This can reduce the risk of the battery running out during riding. User convenience can thus be increased.

### Fourteenth Embodiment

The controller 14 in the first embodiment causes the presentation interface 15 to display the identified bicycle 2. The controller 14 in the fourteenth embodiment may communicate with the identified bicycle 2 and cause the presentation interface 22 to display an indication of identification to allow visual confirmation by the user.

### Fifteenth Embodiment

The controller 14 in the first embodiment identifies the bicycles 2 that can be rented out and causes the presentation interface 15 to display information related to the identified bicycles 2. The controller 14 in the fifteenth embodiment transmits information related to the number of parked bicycles 2 and the batteries to the management server 5. The management server 5 receives the information related to the number of bicycles 2 and the batteries from a plurality of management apparatuses 1 and stores the information. A user wishing to borrow a bicycle 2 operates a user terminal in the user's possession at any location away from the bicycle parking facility, such as the user's home, to launch a dedicated application for utilizing a bicycle rental service, thereby connecting to the management server 5. At this time, the user terminal receives information related to rentable bicycles 2 and position information of the bicycle parking facility where the rentable bicycles 2 are parked from the management server 5 and displays the received information on a display of the user terminal. Without being at the bicycle parking facility, the user can thereby recognize which bicycle parking facility the user can visit to borrow a bicycle 2.

### Sixteenth Embodiment

In the first embodiment, it is determined whether the first battery 23 has the necessary remaining battery level. The battery that is charged by the power transmission apparatus 4 is the first battery 23 in the first embodiment. In the sixteenth embodiment, however, it is determined whether the second battery 26 has the necessary remaining battery level. The battery that is charged by the power transmission apparatus 4 is the second battery 26.

### Seventeenth Embodiment

The controller 14 presents a bicycle 2 that has a first battery 23 with the necessary remaining battery level during the processing to rent out a bicycle in the first embodiment. The controller 14 presents the bicycle 2 that has the first battery 23 with the maximum remaining battery level during the processing to rent out a bicycle in the seventeenth embodiment.

### Eighteenth Embodiment

In the first embodiment, a two-wheeled bicycle is rented out by the management apparatus 1 and is used. Instead of a two-wheeled bicycle, a vehicle such as a tricycle, an electric standing bicycle, a wheelchair, a pushcart, an automobile, or the like may be rented out by the management apparatus 1 and used in the eighteenth embodiment.

Much of the subject matter of the present disclosure is described as a series of operations executed by a computer system and other hardware that can execute program instructions. Examples of the computer system and other hardware include a general-purpose computer, a personal computer (PC), a dedicated computer, a workstation, a personal communications system (PCS), a mobile (cellular) phone, a mobile phone with a data processing function, an RFID receiver, a game device, an electronic notepad, a laptop computer, a global positioning system (GPS) receiver, and other programmable data processing apparatuses. It should be noted that in each embodiment, various operations are executed by a dedicated circuit (for example, individual logical gates interconnected in order to execute a particular function) implemented by program instructions (software), or by a logical block, program module, or the like executed by one or more processors. The one or more processors that execute a logical block, program module, or the like include, for example, one or more of a microprocessor, CPU, application specific integrated circuit (ASIC), digital signal processor (DSP), programmable logic device (PLD), field programmable gate array (FPGA), processor, controller, microcontroller, microprocessor, electronic device, other apparatus designed to be capable of executing the functions disclosed here, and/or a combination of any of the above. The disclosed embodiments are, for example, implemented by hardware, software, firmware, middleware, microcode, or a combination of any of these. The instructions may be program code or a code segment for executing the necessary tasks. The instructions may be stored on a machine-readable, non-transitory storage medium or other medium. The code segment may indicate a combination of any of the following: procedures, functions, subprograms, programs, routines, subroutines, modules, software packages, classes, instructions, data structures, or program statements. The code segment may transmit and/or receive information, data arguments, variables, or memory content to or from another code segment or hardware circuit in order for the code segment to connect to another code segment or hardware circuit.

The network used here may, unless indicated otherwise, be the Internet, an ad hoc network, a local area network (LAN), a wide area network (WAN), a metropolitan area network (MAN), a cellular network, a wireless wide area network (WWAN), a wireless personal area network (WPAN), a public switched telephone network (PSTN), a terrestrial wireless network, another network, or a combination of any of these. A wireless network includes constituent elements such as an access point (e.g. a Wi-Fi access point) and a femtocell, for example. Furthermore, a wireless communication device can connect to a wireless network that uses Wi-Fi, Bluetooth® (Bluetooth is a registered trademark in Japan, other countries, or both), cellular communication technology (such as code division multiple access (CDMA), time division multiple access (TDMA), frequency division multiple access (FDMA), orthogonal frequency division multiple access (OFDMA), or single-carrier frequency division multiple access (SC-FDMA)), or other wireless techniques and/or technical standards. One or more techniques may be adopted for the networks. Such techniques include, for example, universal mobile telecommunications system (UTMS), long term evolution (LTE), evolution-data optimized or evolution-data only (EV-DO), global system for mobile communications (GSM®) (GSM is a registered trademark in Japan, other countries, or both), worldwide interoperability for microwave access (WiMAX), code division multiple access-2000 (CDMA-2000), or time division synchronous code division multiple access (TD-SCDMA).

The circuit configuration of the transmitter, receiver, transmission unit, reception unit, transceiver, or the like provides functionality by using a variety of wireless communication networks, such as WWAN, WLAN, and WPAN. The WWAN may be a network such as a CDMA network, a TDMA network, an FDMA network, an OFDMA network, or a SC-FDMA network. The CDMA network implements one or more Radio Access Technologies (RAT), such as CDMA2000 and Wideband-CDMA (W-CDMA). CDMA2000 includes the IS-95, IS-2000, and IS-856 standards. The TDMA network can implement GSM®, Digital Advanced Phone System (D-AMPS), or another RAT. GSM® and W-CDMA are listed in documents issued by the consortium known as 3rd Generation Partnership Project (3GPP). CDMA2000 is listed in documents issued by the consortium known as 3rd Generation Partnership Project 2 (3GPP2). The WLAN may be an IEEE802.11x network. The WPAN may be a Bluetooth® network, an IEEE802.15x network, or other type of network. CDMA may be implemented as a wireless technique such as Universal Terrestrial Radio Access (UTRA) or CDMA2000. TDMA may be implemented by a wireless technique such as GSM®/General Packet Radio Service (GPRS)/Enhanced Data Rates for GSM® Evolution (EDGE). OFDMA may be implemented by wireless techniques such as Institute of Electrical and Electronics Engineers (IEEE) 802.11 (Wi-Fi), IEEE802.16 (WiMAX), IEEE802.20, or Evolved UTRA (E-UTRA). These techniques may be used in a combination of any of WWAN, WLAN, and/or WPAN. These techniques may also be implemented in order to use an Ultra Mobile Broadband (UMB) network, a High Rate Packet Data (HRPD) network, a CDMA20001× network, GSM®, Long-Term Evolution (LTE), or the like.

The machine-readable, non-transitory storage medium may also be constituted by a computer-readable, tangible carrier (medium) in the categories of solid-state memory, magnetic disks, and optical discs. Data structures and an appropriate set of computer instructions, such as program modules, for causing a processor to execute the techniques disclosed herein are stored on these media. Examples of computer-readable media include an electrical connection with one or more wires, a magnetic disk storage medium, a magnetic cassette, a magnetic tape, or other magnetic and optical storage media (such as a compact disc (CD), laser disc® (laser disc is a registered trademark in Japan, other countries, or both), digital versatile disc (DVD), floppy disk, and Blu-ray Disc), portable computer disk, random access memory (RAM), read-only memory (ROM), rewritable programmable ROM such as EPROM, EEPROM, or flash memory, another tangible storage medium that can store information, or a combination of any of these. The memory may be provided internal and/or external to a processor or processing unit. As used in this disclosure, the term “memory” refers to all types of long-term storage, short-term storage, volatile, non-volatile, or other memory. No limitation is placed on the particular type or number of memories, or on the type of medium for memory storage.

A system including various modules and/or units that execute particular functions has been disclosed. It should be noted that these modules and units have been illustrated schematically to explain their functionality briefly and do not necessarily designate particular hardware and/or software. In this sense, it suffices for the modules, units, and other constituent elements to be hardware and/or software implemented so as to substantially execute the particular functions described here. The various functions or different constituent elements may be combined with or separated from hardware and/or software in any way, and each may be used individually or in some combination. An input/output (I/O) device or user interface including, but not limited to, a keyboard, display, touchscreen, or pointing device may be connected to the system directly or via an I/O controller. In this way, the various subject matter disclosed herein may be embodied in a variety of forms. All such embodiments are included in the scope of the present disclosure.

1. A management system used in a bicycle rental service, the management system comprising:
an acquisition interface configured to acquire remaining battery level information for a bicycle;
a controller configured to identify a bicycle to rent based on the remaining battery level information; and
a presentation interface configured to present information of the bicycle identified by the controller.

2. The management system of claim 1, further comprising:
an input interface configured to receive input of destination information;
wherein the controller is further configured to identify a bicycle to rent based additionally on the destination information.

3. The management system of claim 2,
wherein the input interface is configured to receive input of stopover information; and
wherein the controller is configured to identify a bicycle to rent based additionally on the stopover information.

4. The management system of claim 2, wherein the controller is further configured to
determine whether a destination corresponding to the destination information is a location where power supply by radio waves can be received, and
identify a bicycle based on a distance to the destination in response to the controller determining that the destination is a location where power supply by radio waves can be received.

5. The management system of claim 2,
wherein in response to the controller determining that no bicycle at a first bicycle parking facility can be rented based on the destination information and the remaining battery level information,
the acquisition interface is configured to further acquire remaining battery level information of a bicycle parked at a second bicycle parking facility;
the controller is configured to identify a bicycle having a necessary remaining battery level to reach a destination from the second bicycle parking facility based on the acquired remaining battery level information; and
the presentation interface is configured to display an instruction to travel to the second bicycle parking facility using a bicycle parked at the first bicycle parking facility and having a necessary remaining battery level to reach the second bicycle parking facility from the first bicycle parking facility.

6. The management system of claim 2, wherein in response to the controller determining that no bicycle at a first bicycle parking facility can be rented based on the destination information and the remaining battery level information, the presentation interface is configured to display an instruction to wait.

7. The management system of claim 1, further comprising a power transmission interface, in a power transmission facility, configured to transmit power by radio waves to a battery of the bicycle.

8. The management system of claim 7,
wherein the controller is configured to determine whether a user of the bicycle is authorized to have the bicycle receive power transmission; and
wherein the power transmission interface is configured to transmit power by radio waves to the bicycle in response to the controller determining that the user of the bicycle is authorized to have the bicycle receive power transmission.

9. The management system of claim 7, further comprising:
a second controller configured to determine whether a user of the bicycle is authorized to have the bicycle receive power transmission;
wherein the power transmission interface is configured to transmit power by radio waves to the bicycle in response to the second controller determining that the user of the bicycle is authorized to have the bicycle receive power transmission.

10. The management system of claim 9, wherein the second controller is configured to measure power consumed by the power transmission interface for power transmission.

11. The management system of claim 7, further comprising a third controller configured to measure power consumed by the power transmission interface for power transmission.

12. The management system of claim 1,
wherein the controller is configured
to transmit power by radio waves to a communication terminal including a battery having a remaining battery level less than a threshold and to communicate by radio waves with the communication terminal; and
to communicate by radio waves with a communication terminal including a battery having a remaining battery level equal to or greater than the threshold.

13. The management system of claim 1,
wherein the controller is configured to identify a plurality of bicycles having a remaining battery level equal to or greater than a threshold; and
the presentation interface is configured to present each of the plurality of bicycles in descending order of the remaining battery level.

14. The management system of claim 13,
wherein the acquisition interface is configured to acquire information related to the plurality of bicycles; and
wherein the presentation interface is configured to present the acquired information related to the plurality of bicycles.

15. The management system of claim 14, wherein the information related to the plurality of bicycles includes at least one of the following for each of the plurality of bicycles: an exterior image, an identification number, a number of years in operation, a distance traveled, a date of maintenance, a color, a type, a remaining battery level, a travel range calculated based on the remaining battery level, an estimated operating time calculated based on the remaining battery level, and a number of charge/discharge cycles of the battery.

16. A bicycle comprising:
a battery; and
a controller configured to notify a management apparatus of a remaining level of the battery while the bicycle is parked at a bicycle parking facility.

17. The bicycle of claim 16, further comprising:
an input interface configured to receive a change of destination;
wherein the controller is further configured to determine whether a remaining level of the battery is sufficient based on a current location and destination information after the change.

18. The bicycle of claim 17, further comprising:
a communication interface capable of communicating with an external communication device;
wherein in response to determination that the remaining level of the battery is not sufficient, the communication interface is configured to transmit predetermined information to the external communication device, the predetermined information including at least information related to a facility where a supply of power to the battery can be received.

19. A control method of a management system used in a bicycle rental service, the control method comprising:
acquiring remaining battery level information of a bicycle;
identifying a bicycle to rent based on the remaining battery level information; and
presenting information of the identified bicycle.

20. A non-transitory computer-readable storage medium storing a program for causing a management system used in a bicycle rental service to execute the steps of:
acquiring remaining battery level information of a bicycle;
identifying a bicycle to rent based on the remaining battery level information; and
presenting information of the identified bicycle.
